(19) United States
(12) Patent Application Publication
(10) Pub. No.: US 2009/0165349 A1
(43) Pub. Date: Jul. 2, 2009

(54) Integrated Contact Indication and Label Holder

(75) Inventors: Virendra Singh Bura, Mumbai (IN); Satbir Singh, Mumbai (IN)

Correspondence Address: CENTRAL COAST PATENT AGENCY, INC, 3 HANGAR WAY SUITE D, WATSONVILLE, CA, 95076, US

(73) Assignee: LARSEN & TOUBRO LIMITED, Mumbai (IN)

(21) Appl. No.: 12/344,823

(22) Filed: Dec. 29, 2008

(30) Foreign Application Priority Data
Dec. 27, 2007 (IN) 2593/MUM/2007

(51) Int. Cl. G09F 3/18; G02B 27/02

(52) U.S. Cl. 40/661; 40/642.02; 40/661.06; 40/655; 359/804

(57) ABSTRACT

The embodiment provide an assembly of contact indication and label holder using the same component for switching devices to provide safety indications to the technicians or end users. The assembly comprises of a tag and label holder. Tagging arrangement consists of an indication window for indication status of MCB i.e. ON/OFF and two hinges for holding label holder. The component also has two windows, which are intended for locking of label holder and groove for holding indicating paper. The user can write details on this indicating paper i.e. with which place it is connected and other details. The label holder has an inbuilt lens for giving contact indication a zooming effect for clear differentiation between red and green color of indication flag.

### BACKGROUND

1. Technical Field

The embodiments herein generally relate to switching devices and more particularly it relates to contact indication and label holder for switching devices such as miniature circuit breaker, residual current circuit breaker, and isolator to provide safety indications to the technicians or end users.

2. Description of the Related Art

Switching devices such as miniature circuit breakers, residual circuit breakers and isolators etc are used in domestic and industrial applications for protection against over currents. It is generally required to control electrical power networks by switching circuit “ON”, by carrying load and by switching circuit “OFF” under manual or automatic suspension. Whenever there is an over current resulting in an electrical circuits, the contacts in the switching devices open or trips to block the current which is greater then the rating of the current device.

There are several provisions available to control the electrical contacts. In some cases it includes manual operation, where the moving contact is moved in conjunction with the fixed contact to open or close the electrical connection. In other cases, whenever the over current occurs in the power circuits, the circuit breakers trips automatically to break the contacts. The function of the circuit breakers is to maintain two stable conditions close and open.

However in certain cases the switching devices operate due to fault. During operation of switching devices like miniature circuit breaker, residual current circuit breaker, and isolator, there are chances that due to high currents contact gets welded and current still flows through circuit even if knob of device showing it in “OFF” state. During the maintenance if someone comes in direct contact with circuit, thinking breaker is “OFF”, it may result in serious shock and can be fatal. In some circumstances the moving contact remains stuck on fixed contact with an adhesive force such that the mechanism is not enough to break the joint. In such exceptional circumstances, it is necessary that the switch control indicates the closed position of the switch.

Generally operating knob of switching device is hinged about an axis rotating between certain angles. The operating knob has two stable states, “OFF” and “ON” between which it gets toggled. However in certain cases when switching devices operates due to fault i.e. knob changes its position from “ON” to “OFF”, sometimes the contacts gets welded and current still flows through device. Due to the wrong indication of contacts, accident can occur with operator. In order to notice such a condition there should be some means to detect the status of the circuit breaker i.e. either “ON” or OFF. In industrial and domestic applications it is very important for the technicians and the end users to know the working of an electrical load or appliance connected to the power circuit before working on it. When several technicians are engaged in serving the electrical equipment, there is a need to identify if switching devices is turned “OFF” and “ON”. There is a need of provision for proper identification in device itself.

Prior art provide the method for true contact indication and identification of switching devices at the same platform. In conventional indication system, if seen from a distance, many times it is difficult to differentiate red and green colour in indication window as both look as black due to small size which creates confusion. Many switching devices are having either contact indication or label holder for identification, which are much complex in assemblies and are time consuming.

It is very essential that switching device should indicate its true or actual contact positions i.e. either “ON” or “OFF”. In domestic or industrial applications there are chances that due to lack of proper identification on switching devices operator switches “ON” or “OFF” wrong device which can be problematic sometimes. So there should be the provision for proper identification in device itself. Technicians find difficult to identify the true contact of the switching devices and also in identifying the switching devices which is time consuming. Each time technicians are required to inspect the switching devices for proper identification. Hence there is a need to develop an improved means for contact indication and identification of switching devices for user reliability which consumes less time. There is a further need to provide both features (contact indication and label holder) for identification using same component to reduce cost and improve efficiency of assembly.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concept of the invention in a simplified form as a prelude to the more detailed description that is presented later.

The embodiments of present invention provides an assembly of contact indication and label holder using the same platform for switching devices to provide safety indications to the technicians or end users. The embodiments of present invention also provide method for identification of switching device so as to avoid the manual switching of unwanted breakers. The user can put small paper strip in label holder mentioning the name i.e. with which place it is connected e.g. kitchen, store, bedroom etc and other details. In case of accidents or fire in electric wiring or appliances of a particular area or room user can easily identify which switch is needed to be switched “OFF”.

The assembly comprises of a tag and label holder. Tagging arrangement consists of an indication window for the indication status of MCB i.e. ON/OFF and two hinges for holding label holder. The component also has two windows, which are intended for locking of label holder and groove for holding indicating paper. The label holder revolves about the two hinges. Label holder consists of two holes to be fitted in tag and two locks for locking in windows of tag while holding paper. This label holder is made up of transparent material. The label holder has an inbuilt lens for giving contact indication a zooming effect so that it is easier to differentiate between red and green colour of indication flag even from distance. Indicating paper is used for indication purpose that rests on transparent label holder. Users can write important details on the paper that indicates which switch is connected to which component or circuit.

In assembly of tag and label holder, the label holder is fitted to tag from one side first i.e. one of hinges of tag is inserted in one of holes of label holder and then pressed against second hinge. Label holder can easily revolve about hinges of tag. Indicating paper is inserted into the groove intended and label holder is pressed against tag and it gets locked.

Red indication flag and green indication flag are connected to indication tag assembly. When indication tag assembly is placed on the housing, the red indication flag or green indication flag is visible through the indication window depending upon the status of switch i.e. “ON” or “OFF”. Green indication flag is directly connected to moving contact (moving contact connects and breaks the contacts) with pivot. The pivot is a metallic pin that links the mechanism of the switch with the moving contact. When moving contact becomes inclined (i.e. switch in “ON” position), the green indication flag move up making red indication flag visible through the indication window. When knob is in “OFF” position the green indication flag is visible through the indication window. When the breaker is switched “ON” i.e. knob is pushed up, due to mechanism linkages moving contact moves towards right or becomes inclined. The green indication flag is directly connected to moving contact with pivot so it moves up making red indication flag visible through the indication window.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates unassembled tag and label holder components.

FIG. 2 illustrates tag and label holder assembly with indicating paper.

FIG. 3 illustrates MCB with label holder and indication tag in “OFF” position.

FIG. 4 illustrates MCB with label holder and indication tag (unassembled) in “ON” position.

FIG. 5 illustrates MCB with label holder and indication tag (assembled) in “ON” position.

Although specific features of the present invention are shown in some drawings and not in others. This is done for convenience only as each feature may be combined with any or all of the other features in accordance with the present invention.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The preferred embodiment provides an assembly of contact indication and label holder using the same component for switching devices to provide safety indications to the technicians or end users. The present invention also deals with the identification of switching device so as to avoid the manual switching of unwanted breakers. The assembly comprises of a tag and label holder. Tagging arrangement consists of an indication window for indication status of MCB i.e. ON/OFF and two hinges for holding label holder. The component also has two windows, which are intended for locking of label holder and groove for holding indicating paper. The label holder revolves about the two hinges. Label holder consists of two holes to be fitted in the tag and two locks for locking in windows of the tag while holding paper. The label holder is made up of transparent material. The label holder has an inbuilt lens for giving contact indication a zooming effect so that it is easier to differentiate between red and green color of indication flag even from distance. Indicating paper is used for indication purpose and rests on transparent label holder. Users can write important details on this paper that will indicate which switch is connected to which component or circuit.

In assembly of tag and label holder, the label holder is fitted to tag from one side first i.e. one of hinges of tag is inserted in one of holes of label holder and then pressed against second hinge. Now label holder can easily revolve about hinges of tag. Indicating paper is inserted into the groove intended and label holder is pressed against tag and it gets locked.

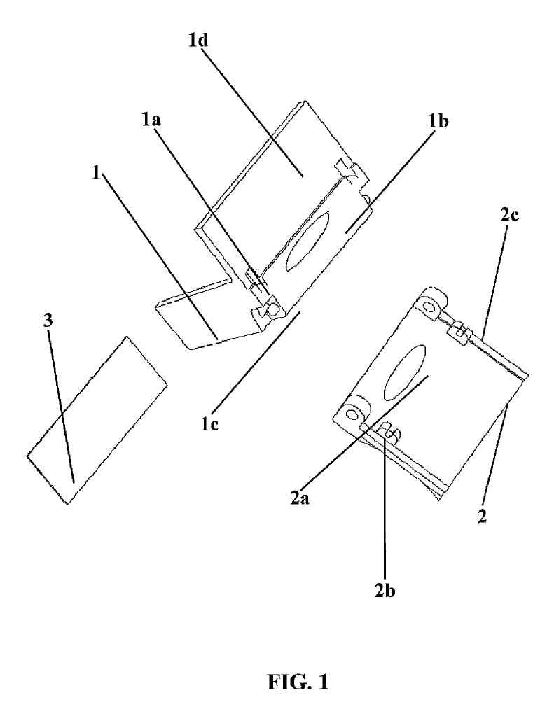

FIG. 1 illustrates unassembled arrangement of tag 1, label holder 2 and paper 3. Tag 1 arrangement comprises window 1b for the indication status of MCB i.e. ON/OFF and two hinges 1c for holding label holder 2. The component also has two windows 1a, which are intended for locking of label holder 2 and groove 1d for holding indicating paper 3. Label holder 2 revolves about two hinges 1c. Label holder 2 comprises of two holes 2b to be fitted in tag 1 and two locks 2c for locking in windows 1a of tag 1 while holding indicating paper 3. This component is made up of transparent material. The component also has an inbuilt lens 2a for giving contact indication a zooming effect. Indicating paper 3 is used for indication purpose and is placed on transparent label holder 2. User can write on the indicating paper 3. Paper 3 indicates which switch is connected to which room or circuit and any other details written on it.

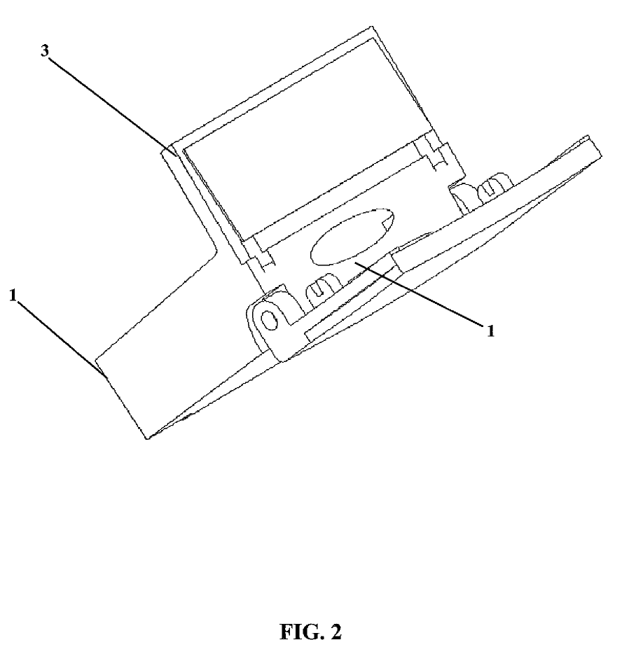

FIG. 2 illustrates tag 1 and label holder 2 assembly with paper 3. In assembly of tag 1 and label holder 2, label holder 2 is fitted to tag 1 from one side in such a way that one of hinges 1c of tag 1 is inserted in one of holes 2b of label holder 2 and then pressed against second hinge 1c. Label holder 2 revolves about hinges 1c of tag 1. Indicating paper 3 in inserted into the groove 1d intended for holding paper 3. Then label holder 2 is pressed against tag 1 and gets locked.

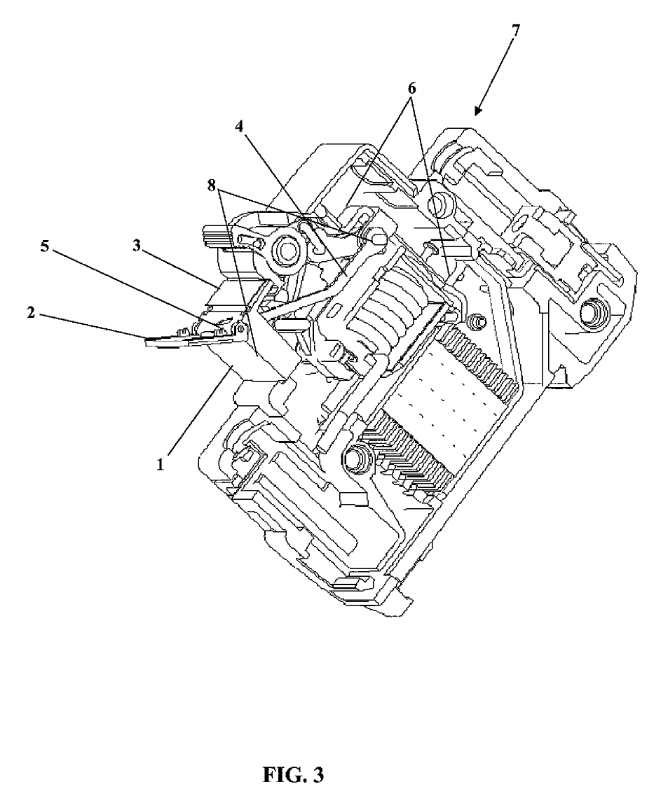

FIG. 3 illustrates tag 1 and label holder 2 assembly, and arrangement of indicating paper 3 to be placed in label holder 2. When knob is in “OFF” position green indication flag 4 is visible through the indication window 1b. When the breaker is switched “ON” i.e. knob is pushed up, moving contact 6 moves towards right or becomes inclined. As green indication flag 4 is directly connected to moving contact 6 with pivot 8, it moves up making red indication flag 5 visible through indication window 1b (as shown in FIG. 1). When indication tag assembly is on the housing 7 then red indication flag 5 or green indication flag 4 is visible through the indication window 1b (as shown in FIG. 1) depending upon the status of switch i.e. “ON” or “OFF”.

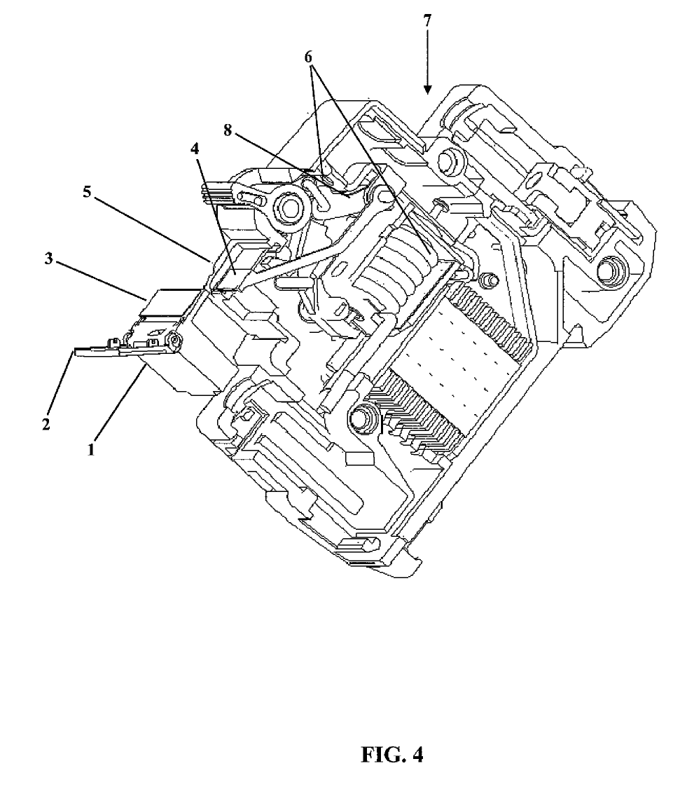

FIG. 4 shows how tag 1 and label holder 2 assembly is assembled to MCB and how flags (red flag 5 and green flag 4) indicate true contact position of moving contact 6.

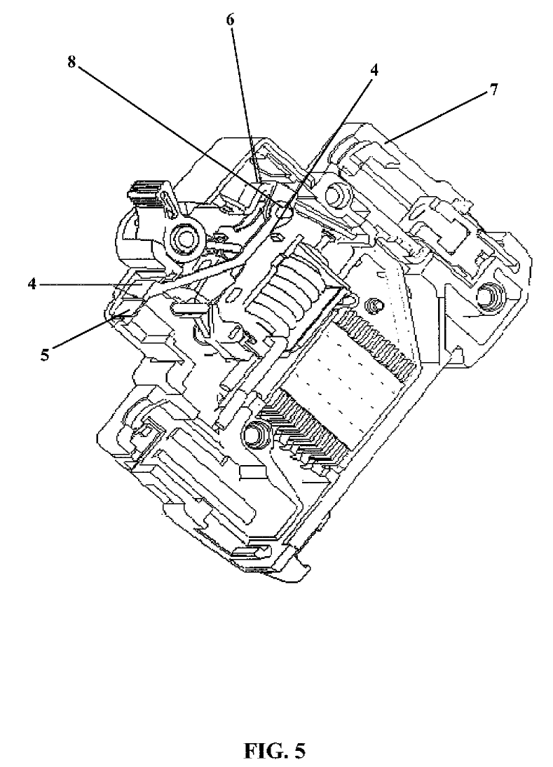

FIG. 5 shows the MCB in “ON” condition and the indication link showing red flag 5 in the indication window 1a. Green flag 4 moves upwards along with the mechanism pivot 8 as the MCB is turned “ON” from “OFF” position. In this position red flag 5 can be seen in the indication window 1a. Moving contact 6 is the contact of switch which makes and breaks contacts. In FIG. 4 moving contact is in vertical position and no contact is made, and in FIG. 5 as knob of switch is pushed, then due to mechanism coupling moving contact 6 becomes inclined and makes contact. If indication tag assembly is removed from housing 7, red indication flag 5 and green indication flag 4 is visible completely. In FIG. 4 indication tag assembly is partially removed from housing and in FIG. 5, it is completely removed and red indication flag 5 and green indication flag 4 are completely visible. Green indication flag 4 will also come under indication tag assembly. Green indication flag 4 is directly connected to moving contact 6 with pivot 8. When moving contact 6 becomes inclined (i.e. switch in “ON” position) as shown in FIG. 5, green indication flag 4 also moves up making red indication flag 5 visible through indication window 1b.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A contact indication and label holder system to provide switching condition indications and identification label for a switching device; said system comprising:
a tag component;
a label holder component; and
an indication paper.

2. The system of claim 1, wherein tag component further comprises of:
an indication window;
two hinges;
two windows; and
a groove.

3. The system of claim 2, wherein said indication window indicates ON/OFF status of switching device.

4. The system of claim 2, wherein said hinges hold said label holder.

5. The system of claim 2, wherein said windows are used for locking of label holder with tag component.

6. The system of claim 2, wherein said groove is used for holding said indication paper.

7. The system of claim 1, wherein said label holder component has a lens for giving contact indication a zooming effect.

8. The system of claim 1, wherein said label holder is made up of transparent material.

9. The system of claim 1, wherein said label holder revolves about said two hinges of said tag.

10. The system of claim 1, wherein said indication paper is used for identification details of said switching device.

11. The system of claim 1, wherein said indication paper is inserted between said tag and said label holder.

12. The system of claim 1, wherein said system is attached to indicator lever of switching device.

13. The system of claim 1, wherein circuit breaker housing contains said system.
